(19) United States
(12) Patent Application Publication
(10) Pub. No.: US 2018/0336564 A1
(43) Pub. Date: Nov. 22, 2018

(54) IDENTITY IDENTIFICATION SYSTEM AND METHOD

(71) Applicants: CHI-CHING CHEN, TAIPEI CITY (TW); NET ALLIANCE CO., LTD., NEW TAIPEI CITY (TW)

(72) Inventor: CHI-CHING CHEN, TAIPEI CITY (TW)

(21) Appl. No.: 15/702,891

(22) Filed: Sep. 13, 2017

(30) Foreign Application Priority Data
May 19, 2017 (TW) 106116773

(51) Int. Cl. G06Q 20/40; H04W 12/06; G06Q 20/38; G06Q 20/32; G06Q 20/36

(52) U.S. Cl. CPC G06Q 20/4014; H04W 12/06; G06Q 20/38215; G06Q 2220/00; G06Q 20/36; H04L 2209/805; G06Q 20/3278

(57) ABSTRACT

The present invention provides an identity identification system and method. The identity identification system comprises a first RFID tag, at least one wireless signal sensing device, and a server device. The first RFID tag is an RFID tag capable of long distance communication, disposed on a portable object, and for transmitting a first identification signal. The first identification signal is a wireless signal of long distance, and includes a user identification code. When the portable object carried by a user is through a signal sensing area of the wireless signal sensing device, the wireless signal sensing device will sense the first identification signal and transmit the first identification signal to the server device. The server device determines the user's identity by the identification of the user identification code of the first identification signal, and therefore decides whether a service of picking up goods or paying is executed.

This non-provisional application claims priority claim under 35 U.S.C. § 119 (a) on Taiwan Patent Application No. 106116773 filed May 19, 2017, the entire contents of which are incorporated herein by reference.

### FIELD OF THE INVENTION

The present invention relates to an identifiable identification system and method, more particularly, to a system and method capable of executing an identity identification process for the user.

### BACKGROUND

In the past, the user must deliver a membership card, a credit card, or a ticket to the service personnel before the user desires to enter a membership place (such as Costco store, airport Lounge) or an event venue (such as a concert venue). The user will be allowed to enter the membership place or the event venue after the service personnel determines the identity of the user by identifying the membership card, the credit card, or the ticket.

When too many peoples want to enter the membership place or the event venue, the approach time will be affected because the service personnel must need to identify everyone's the membership card, the credit card, or the ticket one by one. Besides, with the progression of technology nowadays, the membership cards, credit cards or tickets are easy to be forged. The service personnel is not easy to identify the authenticity of the membership cards, the credit cards or the tickets directly through the human eye, so that peoples with bad intentions hold the forged membership cards, credit cards or tickets to enter the membership place or the event venue.

Accordingly, the user must take out the card or the ticket to the service personnel for inspection in the executing of the identity identification process formerly. Such a way of the prior identification that not only needs more inspection time, and can not accurately identify the authenticity of the card or ticket.

### SUMMARY

It is one object of the present invention to provide an identity identification system, which comprises an RFID tag that is capable of transmitting a user identification code, and disposed on a portable object. The identity identification system will sense an identification signal including the user identification code in a way of long-distance sensing when the portable object carried by a user is through the signal sensing area of the identity identification system. Afterwards, the identity identification system executes a comparison between the user identification code of the identification signal and each of identity data in user databases of a cloud device so as to know the identity of the user.

It is one object of the present invention to provide an identity identification system, which is applied in an identity identification of member pickup. The user orders at least one goods on a member platform of the cloud device to generate a pickup list, the pickup list is stored in the corresponding user database of the cloud device. When the portable object carried by the user is through an identification area of a pickup place, the identity identification system will execute an identity identification process for the user identification code transmitted by the RFID tag of the portable object, and search out the pickup list from the user database of the cloud device according to an identity identification result. Afterwards, a service personnel at the identification area of the pickup place can deliver the ordered goods to the ordered user based on the pickup list.

It is one object of the present invention to provide an identity identification system, which is applied in an identity identification of shopping payment. The identity identification system configures an RFID tag, capable of transmitting a product information, on each of products. When the portable object carried by the user and the product taken by the user are through a checkout area of a shop, the identity identification system will execute an identity identification process for the user identification code transmitted by the RFID tag of the portable object, and execute a product identification process for the product information transmitted by the RFID tag of the product. After the identity identification system determines the identity of the user and the product taken away by the user, it will search out a corresponding user payment account according to the identity identification result, and sends a payment request for the product amount of money to a payment unit based on the payment account of the user so as to complete the payment of shopping of the user.

To achieve the above object, the present invention provides an identity identification system, comprising: a first RFID tag, being an RFID tag capable of long-distance communication, and disposed on a portable object, wherein the first RFID tag is for transmitting a first identification signal, the first identification signal is a wireless signal of long-distance, and includes a user identification code; at least one wireless signal sensing device having a signal sensing area, wherein the wireless signal sensing device will sense the first identification signal in a way of long-distance sensing when the portable object carried by a user is through the signal sensing area of the wireless signal sensing device; and a server device connected to the wireless signal sensing device, wherein the server device comprises a plurality of user databases, each of the user databases records an identity data with regarding to each of the users, respectively, the first identification signal is transmitted to the server device by the wireless signal sensing device, the server device is able to identify an identity of the user according to a comparison between the user identification code of the first identification signal and each of the identity data.

In one embodiment of the present invention, the user orders at least one goods on a member platform of the server device, the server device generates a pickup list according to the goods ordered by the user, and stores the pickup list to the corresponding user database.

In one embodiment of the present invention, the server device executes the comparison between the user identification code of the first identification signal and each of the identity data to generate a member identity identification result, the server device searchs out the pickup list from the user databases according to the member identity identification result, the server device transmits the member identity identification result and the pickup list to the wireless signal sensing device, a service personnel at the signal sensing area of the wireless signal sensing device can determine the identity of the user based on the member identity identification result, and deliver the ordered goods to the ordered user based on the pickup list.

In one embodiment of the present invention, the identity identification system further comprises at least one second RFID tag, the second RFID tag is disposed on a product, the second RFID tag is for transmitting a second identification signal, the second identification signal is a wireless signal of long-distance and includes a product information, the wireless signal sensing device will sense the first identification signal and the second identification signal in the way of long-distance sensing when the portable object carried by the user and the product taken by the user are through the signal sensing area of the wireless signal sensing device, the first identification signal and the second identification signal are transmitted to the server device via the wireless signal sensing device, the server device is able to identify the identity of the user according to the comparison between the user identification code of the first identification signal and each of the identity data, and determine the product taken away by the user according to an identification of the product information of the second identification signal.

In one embodiment of the present invention, the first RFID tag comprises a first RF chip and a first antenna, the second RFID tag comprises a second RF chip and a second antenna, the first RF chip is configured with the user identification code, the first RF chip transmits the first identification signal including the user identification code by the first antenna, the second RF chip is configured with the product information, the second RF chip transmits the second identification signal including the product information by the second antenna.

In one embodiment of the present invention, the first RFID tag and the second RFID tag are an RFID tag of ultra high frequency, respectively.

In one embodiment of the present invention, each of the user databases further records a payment account of the user, respectively, the product information of the second identification signal comprises a product amount of money, the server device is able to search out the payment account of the user from the user databases according to the identification of the identity of the user, and know the product amount of money, which is corresponding to the product taken away by the user, according to the identification of the product information of the second identification signal, the server device sends a payment request including the product amount of money and the payment account of the user to a payment unit.

In one embodiment of the present invention, the payment account is a credit card data, a bank account number, an electronic wallet account or an electronic payment account.

In one embodiment of the present invention, the wireless signal sensing device comprises a first encryption and decryption unit, the server device comprises a second encryption and decryption unit, the wireless signal sensing device is able to encrypt the first identification signal and the second identification signal by the first encryption and decryption unit to obtain a first encryption identification signal and a second encryption identification signal, the first encryption identification signal and the second encryption identification signal are transmitted to the server device by the wireless signal sensing device, the server device is able to decrypt the first encryption identification signal and the second encryption identification signal by the second encryption and decryption unit to obtain the first identification signal and the second identification signal.

In one embodiment of the present invention, the identity identification system further comprises a photographic device that is connected to the wireless signal sensing device and provided in the signal sensing area, the photographic device is for shooting the user and the product taken away by the user to obtain an image data including a shooting time, the image data is transmitted to the server device by the wireless signal sensing device so as to store in the corresponding user database.

In one embodiment of the present invention, the identity identification system further comprises an alert unit that is connected to the wireless signal sensing device and provided in the signal sensing area, the server device sends an alert signal to the wireless signal sensing device when the server device identifies that the user identification code is an error identification code, the wireless signal sensing device drives the alert unit according to the alert signal.

In one embodiment of the present invention, the identity identification system further comprises an alert unit that is connected to the wireless signal sensing device and provided in the signal sensing area, the photographic device is a photographic device capable of tracking and detecting a moving object, the alert unit will be driven by the wireless signal sensing device when the photographic device detects that someone passes through the signal sensing area but the wireless signal sensing device does not sense the first identification signal.

In one embodiment of the present invention, the identity identification system comprises a plurality of the wireless signal sensing devices, each of the wireless signal sensing devices is provided in a corresponding shop and configured with a shop code, respectively, the server device further comprises a shop database that records a financial account of each of the shops, the wireless signal sensing device of the shop will sense the first identification signal and the second identification signal in the way of long-distance sensing when the portable object carried by the user and the product taken by the user are through the signal sensing area of the wireless signal sensing device of the shop, then, the first identification signal, the second identification signal, and a third identification signal including the shop code are transmitted to the server device via the wireless signal sensing device of the shop, the server device is able to identify the identity of the user according to the comparison between the user identification code of the first identification signal and each of the identity data, the server device is able to know the product amount of money, which is corresponding to the product taken away by the user, according to the identification of the product information of the second identification signal, the server device is able to determine whether the shop that is transmitting the first identification signal, the second identification signal, and the third identification signal is a registered shop according to an identification of the shop code of the third identification signal; afterwards, if the server device has determined the shop as the registered shop according to the identification of the shop code, it will further search out the corresponding shop financial account from the shop database according to the shop code, and send an appropriation request including the product amount of money and the shop financial account to the payment unit.

In one embodiment of the present invention, the wireless signal sensing device comprises a first encryption and decryption unit, the server device comprises a second encryption and decryption unit, the wireless signal sensing device is able to encrypt the first identification signal, the second identification signal, and the third identification signal by the first encryption and decryption unit to obtain a first encryption identification signal, a second encryption identification signal, and a third encryption identification signal, the first encryption identification signal, the second encryption identification signal, and the third encryption identification signal are transmitted to the server device by the wireless signal sensing device, the server device is able to decrypt the first encryption identification signal, the second encryption identification signal, and the third encryption identification signal by the second encryption and decryption unit to obtain the first identification signal, the second identification signal, and the third identification signal.

The present invention further provides an identity identification method, which is applied in an identity identification system, wherein the identity identification system comprises a first RFID tag, at least one wireless signal sensing device, and a server device, the first RFID tag is an RFID tag capable of long-distance communication and disposed on a portable object, the wireless signal sensing device is having a signal sensing area, the server device comprises a plurality of user databases, each of the user databases records an identity data with regarding to each of the users, respectively, steps of the identity identification method comprising: transmitting a first identification signal including a user identification code by the first RFID tag; enabling the wireless signal sensing device sensing the first identification signal transmitted by the first RFID tag in a way of long-distance sensing when the portable object carried by a user is through the signal sensing area of the wireless signal sensing device; transmitting the first identification signal to the server device by the wireless signal sensing device; and enabling the server device executing a comparison between the user identification code of the first identification signal and each of the identity data to identify an identity of the user.

In one embodiment of the present invention, the steps of the identity identification method further comprising: ordering at least one goods on a member platform of the server device by the user so that the server device generates a pickup list and stores the pickup list to the corresponding user database; enabling the server device executing the comparison between the user identification code of the first identification signal and each of the identity data to generate a member identity identification result; searching out the pickup list from the user databases according to the member identity identification result by the server device; transmitting the member identity identification result and the pickup list to the wireless signal sensing device by the server device; and demanding a service personnel at the signal sensing area of the wireless signal sensing device to determine the identity of the user based on the member identity identification result and deliver the ordered goods to the ordered user based on the pickup list.

In one embodiment of the present invention, the identity identification system further comprises a second RFID tag disposed on a product, the steps of the identity identification method further comprising: transmitting a second identification signal comprising a product information by the second RFID tag; enabling the wireless signal sensing device sensing the first identification signal transmitted by the first RFID tag and the second identification signal transmitted by the second RFID tag in the way of long-distance sensing when the portable object carried by the user and the product taken by the user is through the signal sensing area of the wireless signal sensing device; transmitting the first identification signal and the second identification signal to the server device by the wireless signal sensing device; enabling the server device executing the comparison between the user identification code of the first identification signal and each of the identity data to identify the identity of the user; and determining the product taken away by the user according to an identification of the product information of the second identification signal.

In one embodiment of the present invention, each of the user databases further records a payment account of the user, respectively, the product information of the second identification signal comprises a product amount of money, the steps of the identity identification method further comprising: searching out the payment account of the user from the user databases according to the identification of the identity of the user by the server device; enabling the server device identifying the product information of the second identification signal to know the product amount of money that is corresponding to the product taken away by the user; and sending a payment request including the product amount of money and the payment account of the user to a payment unit by the server device.

In one embodiment of the present invention, the steps of the identity identification method further comprising: enabling the wireless signal sensing device encrypting the first identification signal and the second identification signal by a first encryption and decryption unit to obtain a first encryption identification signal and a second encryption identification signal; transmitting the first encryption identification signal and the second encryption identification signal to the server device by the wireless signal sensing device; and enabling the server device decrypting the first encryption identification signal and the second encryption identification signal by a second encryption and decryption unit to obtain the first identification signal and the second identification signal.

In one embodiment of the present invention, wherein the identity identification system comprises a plurality of the wireless signal sensing devices, each of the wireless signal sensing devices is provided in a corresponding shop and configured with a shop code, respectively, the server device further comprises a shop database that records a financial account of each of the shops, the steps of the identity identification method further comprising: transmitting the first identification signal, the second identification signal, and a third identification signal including the shop code to the server device by the wireless signal sensing device of the shop; enabling the server device identifying the product information of the second identification signal to know the product amount of money that is corresponding to the product taken away by the user; enabling the server device identifying the shop code of the third identification signal to determine whether the shop that is transmitting the first identification signal, the second identification signal, and the third identification signal is a registered shop; enabling the server device searching out the corresponding shop financial account from the shop database according to the shop code when the shop has determined as the registered shop; and sending an appropriation request including the product amount of money and the shop financial account to the payment unit by the server device.

In one embodiment of the present invention, the steps of the identity identification method further comprising: enabling the wireless signal sensing device encrypting the first identification signal, the second identification signal, and the third identification signal by a first encryption and decryption unit to obtain a first encryption identification signal, a second encryption identification signal, and a third encryption identification signal; transmitting the first encryption identification signal, the second encryption identification signal, and the third encryption identification signal to the server device by the wireless signal sensing device; and enabling the server device decrypting the first encryption identification signal, the second encryption identification signal, and the third encryption identification signal by a second encryption and decryption unit to obtain the first identification signal, the second identification signal, and the third identification signal.

The present invention further provides an identity identification system, comprising: a first RFID tag, being a RFID tag capable of short-distance communication, and disposed on a portable object, wherein the first RFID tag is for transmitting a first identification signal, the first identification signal is a wireless signal of short-distance, and includes a user identification code; at least one second RFID tag, being a RFID tag capable of short-distance communication, and disposed on a product, respectively, wherein the second RFID tag is for transmitting a second identification signal, the second identification signal is a wireless signal of short-distance and includes a product information comprising a product amount of money; at least one wireless signal sensing device, wherein the wireless signal sensing device will sense the first identification signal and the second identification signal in a way of near field sensing when the portable object and the product held by a user are close to the wireless signal sensing device; and a server device connected to the wireless signal sensing device, wherein the server device comprises a plurality of user databases, each of the user databases records an identity data and a payment account with regarding to each of the users, respectively, the first identification signal and the second identification signal are transmitted to the server device by the wireless signal sensing device, the server device is able to identify an identity of the user according to a comparison between the user identification code of the first identification signal and each of the identity data, and further search out the payment account of the user from the user databases according to the identity of the user, the server device is able to know the product amount of money, which is corresponding to the product taken away by the user, according to the identification of the product information of the second identification signal, afterwards, the server device sends a payment request including the product amount of money and the payment account of the user to a payment unit.

The present invention further provides an identity identification method, which is applied in an identity identification system, wherein the identity identification system comprises a first RFID tag, at least one second RFID tag, at least one wireless signal sensing device, and a server device, the first RFID tag is a RFID tag capable of short-distance communication and disposed on a portable object, the second RFID tag is a RFID tag capable of short-distance communication and disposed on a product, the server device comprises a plurality of user databases, each of the user databases records an identity data and a payment account with regarding to each of the users, respectively, steps of the identity identification method comprising: transmitting a first identification signal including a user identification code by the first RFID tag; transmitting a second identification signal including a product information by the second RFID tag; enabling the wireless signal sensing device sensing the first identification signal transmitted by the first RFID tag and the second identification signal transmitted by the second RFID tag in a way of near field sensing when the portable object and the product held by a user are close to the wireless signal sensing device; transmitting the first identification signal and the second identification signal to the server device by the wireless signal sensing device; enabling the server device executing the comparison between the user identification code of the first identification signal and each of the identity data to identify the identity of the user; searching out the payment account of the user from the user databases according to the identity of the user by the server device; enabling the server device identifying the product information of the second identification signal to know the product amount of money that is corresponding to the product taken away by the user; and sending a payment request including the product amount of money and the payment account of the user to a payment unit by the server device.

### BRIEF DESCRIPTION OF THE DRAWINGS

FIG. 1 is a structural diagram of an identity identification system according to one application embodiment of the present invention.

FIG. 2 is a structural diagram of an identity identification system according to another application embodiment of the present invention.

FIG. 3 is a structural diagram of an identity identification system according to another application embodiment of the present invention.

FIG. 4 is a structural diagram of an identity identification system according to another application embodiment of the present invention.

FIG. 5 is a structural diagram of an identity identification system according to another application embodiment of the present invention.

### DETAILED DESCRIPTION OF THE PREFERRED EMBODIMENTS

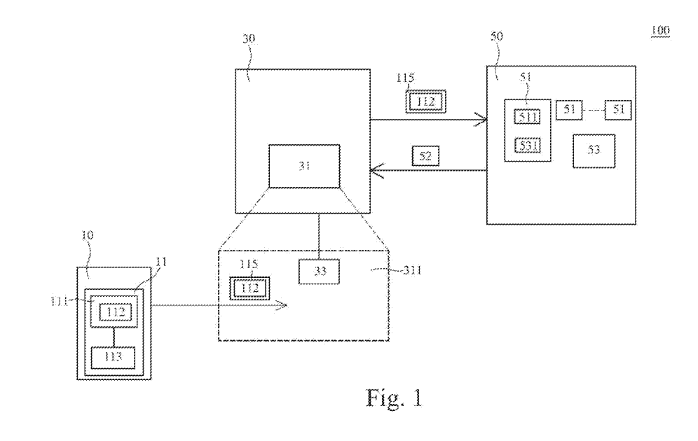

Referring to FIG. 1, there is shown a structural diagram of an identity identification system according to one application embodiment of the present invention. As shown in FIG. 1, the identity identification system 100 comprises a first RFID (Radio Frequency Identification) tag 11, at least one wireless signal sensing device 30, and a server device 50.

The first RFID tag 11 of the present invention is a user's identity identification tag issued by a card issuing institution, a financial institution, or a ticket unit. The first RFID tag 11 is an RFID tag of ultra high frequency capable of long-distance communication. The first RFID tag 11 comprises a first RF (Radio Frequency) chip 111 and a first antenna 113. The first RF chip 111 is connected to the first antenna 113. The first RF chip 111 is configured with a user identification code 112. The user identification code 112 is an unique ID for representing the identity of user. The first RF chip 111 can transmit a first identification signal 115 including the user identification code 112 by the first antenna 113. The first identification signal 115 is a wireless signal of long-distance. The first RFID tag 11 is disposed on a portable object 10. The portable object 10 may be a credit card, a financial card, a membership card, an electronic ticket, a mobile phone, a hand ring, or other object for bearing the first RFID tag 11. The portable object 10 may be carried by a user. For example, the portable object 10 may be placed in a user's wallet or bag; otherwise, the portable object 10 may be handheld or worn by the user.

The wireless signal sensing device 30 is an electronic device including a wireless signal sensor 31, for example, the wireless signal sensing device 30 is a computer device. The wireless signal sensor 31 is an RFID reader capable of sensing RF wireless signal of long-distance, and has a signal sensing area 311.

The server device 50 may be a cloud server equipment. The server device 50 is connected to each wireless signal sensing device 30, and comprises a plurality of user databases 51. Each of the user databases 51 is corresponding to a specific user, respectively. Each of the user databases 51 records an identity data 511 with regarding to each of user, respectively. For example, the identity data 511 comprises identity identification number, name, telephone number, Email and so on of the user.

The wireless signal sensing device 30 will sense the first identification signal 115 transmitted from the first RFID tag 11 in a way of long-distance sensing when the portable object 10 carried by the user is through the signal sensing area 311 of the wireless signal sensing device 30. Afterwards, the wireless signal sensing device 30 will transmit the first identification signal 115 to the server device 50. Thus, the server device 50 is able to identify an identity of the user according to a comparison between the user identification code 112 of the first identification signal 115 and each of the identity data 511 in each of the user databases 51. Besides, the server device 50 further comprises a comparator unit. The comparison between the user identification code 112 of the first identification signal 115 and each of the identity data 511 can be executed by the comparator unit.

Accordingly, the identity identification system 100 of the present invention can sense the user identification code 112 configured on the portable object 10 in the way of long-distance sensing, and execute the identity identification process for the user identification code 112 by a cloud server equipment. Thus, the user does not need to deliver an identification card or ticket to the service personnel in the identity identification process of the identity identification system 100 of the present invention, in such a way that not only the speed of identification of identity can be accelerated, but also can increase the accuracy of identification of identity.

In one application embodiment of the present invention, the identity identification system 100 is applied in an identity identification of member. The wireless signal sensing device 30 is provided in an entrance area of a specific place, the entrance area of the specific place will be located within the signal sensing area 311 of the wireless signal sensing device 30. The user database 51 of the server device 50 is a member database, and the identity data 511 recorded in the user database 51 is a member data. The wireless signal sensing device 30 will sense the first identification signal 115 transmitted from the first RFID tag 11 of the portable object 10 in the way of long-distance sensing when the portable object 10 carried by the user is through the entrance area of the specific place, and transmit the first identification signal 115 to the server device 50. The server device 50 is able to generate a member identity identification result 52 according to a comparison between the user identification code 112 of the first identification signal 115 and the identity data 511 in each of the user databases 51, and then transmit the member identity identification result 52 to the wireless signal sensing device 30. Thus, the service personnel at the specific place can know the user whether has the identity of member via the member identity identification result 52 displayed on a displayer of the wireless signal sensing device 30, and therefore decide whether allows the user to enter or shop.

In another application embodiment of the present invention, the identity identification system 100 is applied in an identity identification of member pickup. The wireless signal sensing device 30 is provided in an identification area of a pickup place (such as superstore), the identification area of the pickup place will be located within the signal sensing area 311 of the wireless signal sensing device 30. The user can order at least one goods on a member platform 53 (such as ordering website) of the server device 50. The server device 50 generates a pickup list 531 according to the goods ordered by the user, and stores the pickup list 531 to the corresponding user database 51. The wireless signal sensing device 30 will sense the first identification signal 115 transmitted from the first RFID tag 11 of the portable object 10 in the way of long-distance sensing when the portable object 10 carried by the user is through the identification area of the pickup place, and transmit the first identification signal 115 to the server device 50. The server device 50 generates a member identity identification result 52 according to a comparison between the user identification code 112 of the first identification signal 115 and the identity data 511 in each of the user databases 51, searches out the pickup list 531 from the user databases 51 according to the member identity identification result 52, and then transmits the member identity identification result 52 and the pickup list 531 to the wireless signal sensing device 30. The service personnel at the identification area of the pickup place can determine the identity of the user based on the member identity identification result 52 displayed on the displayer of the wireless signal sensing device 30, and deliver the ordered goods to the ordered user based on the pickup list 531.

Besides, the identity identification system 100 further comprises an alert unit 33. The alert unit 33 is connected to the wireless signal sensing device 30, and provided in the signal sensing area 311. The server device 50 sends an alert signal to the wireless signal sensing device 30 if the server device 50 identifies that the user identification code 112 is an error identification code. The wireless signal sensing device 30 drives the alert unit 33 to send out an alert according to the alert signal, so as to remind the service personnel that the user currently in the signal sensing area 311 does not have the member's identity.

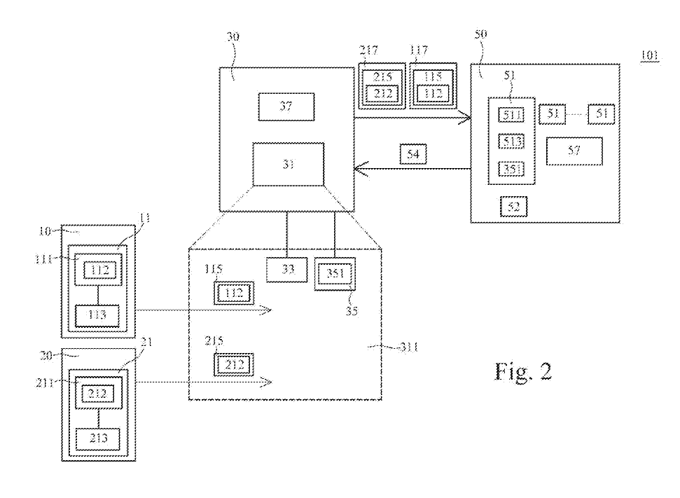

Referring to FIG. 2, there is shown a structural diagram of an identity identification system according to another application embodiment of the present invention. As shown in FIG. 2, the identity identification system 101 of the present invention further comprises at least one second RFID tag 21. The second RFID tag 21 is disposed on a product 20. The product 20 may be a goods, a drug, or other types of object. Similarly, the second RFID 21 is also an RFID tag of ultra high frequency capable of long-distance communication. The second RFID tag 21 comprises a second RF chip 211 and a second antenna 213. The second RF chip 211 is connected to the second antenna 213. The second RF chip 211 is configured with a product information 212. The second RF chip 211 can transmit a second identification signal 215 including the product information 212 by the second antenna 213.

In another application embodiment of the present invention, the identity identification system 101 is applied in an identity identification of shopping payment. The wireless signal sensing device 30 is provided in a checkout area of a shop, the checkout area of the shop will be located within the signal sensing area 311 of the wireless signal sensing device 30. In the present embodiment, the product information 212 includes a product amount of money, each of the user databases 51 further records a payment account 513 of the user. The payment account 513 may be a credit card payment data (such as credit card number, valid use date, and verification code), a bank account number, an electronic wallet account, or an electronic payment account. The wireless signal sensing device 30 will sense the first identification signal 115 transmitted from the first RFID tag 11 of the portable object 10 and the second identification signal 215 transmitted from the second RFID tag 21 of the product 20 in the way of long-distance sensing when the portable object 10 carried by the user and the product 20 taken by the user are through the checkout area of the shop, and then transmit the first identification signal 115 and the second identification signal 215 to the server device 50. The server device 50 generates the member identity identification result 52 according to the comparison between the user identification code 112 of the first identification signal 115 and the identity data 511 in each of the user databases 51, searches out the payment account 513 of the corresponding user from the user databases 51 according to the member identity identification result 52. At the same time, the server device 50 know the product 20 taken away by the user and the product amount of money thereof according to the identification of the product information 212 of the second identification signal 215. Afterwards, the server device 50 sends a payment request including the product amount of money and the payment account 513 of the user to a payment unit, for example, card issuing unit, financial unit, or third party payment unit. After the payment unit agrees the payment request of the server device 50, and debits from the payment account 513 of the user according to the product amount of money of the payment request, the service device 50 sends a payment completed notification message 54 to the wireless signal sensing device 30 and/or the mobile phone used by the user.

Sequentially, people have accustomed to use credit cards for payment already. In the payment way of the credit card formerly, the user takes out the credit card from the wallet, and delivers to the checkout personnel when the user enters the checkout area of the shop. The checkout personnel can read the credit card payment data (such as credit card number, valid use date, and verification code) in magnetic stripe or chip of the credit card by a magnetic card reader or a chip card reader in a way of contact reading, and then the magnetic card reader or the chip card reader can transmit the read credit card payment data to an issuing bank to obtain an authorization of the issuing bank and therefore complete the payment. Otherwise, some credit cards or mobile phones have a wireless sensor chip (such as NFC/RFIC chip) that binds a credit card payment data. In the checkout process, the user or the checkout personnel can take up the credit card (or the mobile phone) having the wireless sensor chip to approach to an RFID reader with short-distance sensing function, the RFID reader will read the credit card payment data in the wireless sensor chip in a way of short-distance and non-contact sensing (such as near field communication, NFC), and then transmit the read credit card payment data to the issuing bank so as to obtain the authorization of the issuing bank and therefore complete the payment. However, the people with bad intentions are very easy to steal the credit card payment data in magnetic stripe or chip of the credit card by a contact recorder in the way of contact reading, or steal the credit card payment data in the wireless sensing chip of the credit card by a non-contact recorder in the way of near field sensing. Afterwards, the people with bad intentions are directly shopping in the internet by the use of the stolen credit card payment data, or the stolen credit card payment data are made into a pseudo-card by the people with bad intentions, the people with bad intentions holds the pseudo-card to pay in the shopping. Accordingly, the user takes out the credit card or the mobile phone to proceed payment, the credit card payment data of which are very easy stolen by others.

As the above described, the differences between the payment process the identity identification system 101 of the present invention and the payment process of the credit card of the prior are as follows: (1). the user must take out the credit card or the mobile phone to deliver for the service personnel during the payment process of the credit card of the past, in such a way that the credit card payment data in the credit card or the mobile phone are easy stolen by others; relatively, the identity identification system 101 of the present invention 101 will automatically sense and identity the user identification code 112 configured in the portable object 10 when the user carrying the portable object 10 enters the checkout area of the shop so as to obtain the identity identification result, and then complete the payment process according to the identity identification result for the user, such the user does not need to take out the credit card or the mobile phone deliver for the service personnel during the payment process of the present invention, so that the credit card payment data can avoid to be stolen; (2). the service personnel at the checkout area of the shop can get the credit card or the mobile phone delivered by the user during the payment process of the credit card of the past, therefore, the credit card payment data are very easy be stolen in checkout area of the shop; relatively, when the user of the present invention enters the checkout area of the shop, anyone at the checkout area of the shop can only obtain the user identification code 112 of the portable object 10 carried by the user in the way of the long distance sensing, and can not get the credit card payment data since the credit card does not need to be taken out during the payment process of the present invention, the user identification code 112 is just a personal identification number for identifying the user's identity, the user identification code 112 is unable to be used for paying even if it is to be stolen in checkout area of the shop.

In the present invention, the wireless signal sensing device 30 further comprises a first encryption and decryption unit 37, the server device 50 comprises a second encryption and decryption unit 57. In one embodiment of the present invention, the first encryption and decryption unit 37 and the second encryption and decryption unit 57 are encryption and decryption chips or encryption and decryption hardware circuits. In another embodiment of the present invention, the first encryption and decryption unit 37 and the second encryption and decryption unit 57 are encryption and decryption algorithms, for example, RES, AES, or DES algorithms, and stored in a storage (such as ROM) in the form of firmware. The wireless signal sensing device 30 is able to encrypt the first identification signal 115 and the second identification signal 215 by the first encryption and decryption unit 37 to obtain a first encryption identification signal 117 and a second encryption identification signal 217. The first encryption identification signal 117 and the second encryption identification signal 217 are transmitted to the server device 50 by the wireless signal sensing device 30. The server device 50 is able to decrypt the first encryption identification signal 117 and the second encryption identification signal 217 by the second encryption and decryption unit 57 to obtain the first identification signal 115 and the second identification signal 215. Accordingly, the identity identification system 101 of the present invention configures an encryption and decryption mechanism between the wireless signal sensing device 30 and the server device 50, the first identification signal 115 and the second identification signal 215 transmitted by the wireless signal sensing device 30 may be protected by encryption so as to reduce the chance of the leakage of the user's shopping information, and further ensure the security in the user's shopping payment.

The identity identification system 101 of the present invention further comprises a photographic device 35. The photographic device 35 is connected to the wireless signal sensing device 30, and provided in the signal sensing area 311, for example, the signal sensing area 311 is the checkout area of the shop. When the user carrying the portable object 10 and taking the product 20 is through the signal sensing area 311, the photographic device 35 will be used for shooting the user and the product 20 taken away by the user to obtain an image data 351 including a shooting time. The image data 351 is transmitted to the server device 50 by the wireless signal sensing device 30 so as to store in the corresponding user database 51. Accordingly, the identity identification system 101 is able to record the user's shopping time and shopping product by the image data 351 shot by the photographic device 35.

Similarly, the identity identification system 101 of the present embodiment is provided with the alert unit 33 in the signal sensing area 311. The photographing device 35 is a photographic device capable of tracking and detecting a moving object. When the photographic device 35 detects that someone passes through the signal sensing area 311 but the wireless signal sensing device 30 does not sense the first identification signal 115, the wireless signal sensing device 30 will drive the alert unit 33 to send out the alert so as to remind the service personnel that the unauthorized person enters the signal sensing area 311.

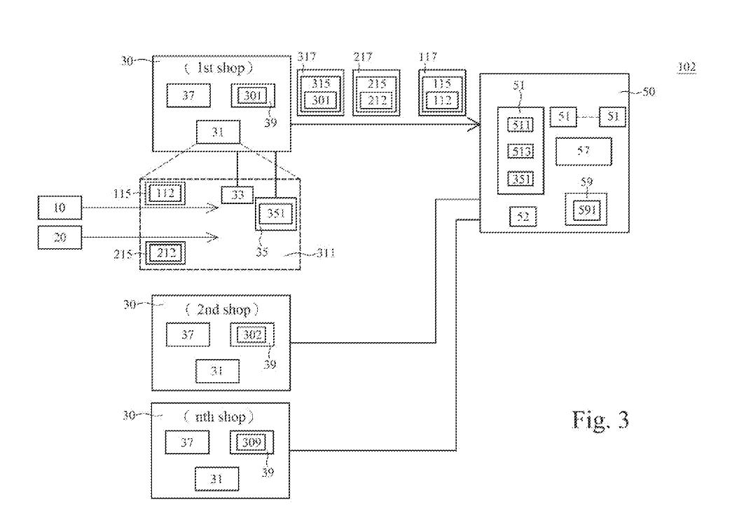

Referring to FIG. 3, there is shown a structural diagram of an identity identification system according to another application embodiment of the present invention. As shown in FIG. 3, the identity identification system 102 of the present invention further comprises a plurality of wireless signal sensing devices 30. Each of wireless signal sensing device 30 is provided in a corresponding shop, respectively.

In the present embodiment, the wireless signal sensing device 30 of each of shops is configured with a shop code, for example, the wireless signal sensing device 30 of the first shop is configured with a shop code 301, the wireless signal sensing device 30 of the second shop is configured with a shop code 302, and the wireless signal sensing device 30 of the nth shop is configured with a shop code 309. The shop code 301, 302, or 309 is stored in the data storage element 39 of each of wireless signal sensing devices 30.

When the identity identification system 102 is applied in the shopping payment, the wireless signal sensing devices 30 of the shop transmits simultaneously a third identification signal 315 including the shop code 301/302/309 to the server device 50 except for transmitting the first identification signal 115 and the second identification signal 215 to the server device 50. The server device 50 is able to generate the member identity identification result 52 according to the comparison between the user identification code 112 of the first identification signal 115 and the identity data 511 in each of the user databases 51, and search out the payment account 513 of the user from the user databases 51 according to the member identity identification result 52. The server device 50 is able to know the product amount of money, which is corresponding to the product taken away by the user, according to the identification of the product information 212 of the second identification signal 215. The server device 50 is able to determine whether the shop that is transmitting the first identification signal 115, the second identification signal 215, and the third identification signal 315 is a registered shop according to an identification of the shop code 301/302/309 of the third identification signal 315. If the server device 50 has determined the shop as the registered shop according to the identification of the shop code 301/302/309, it will further search out the corresponding shop financial account 591 from the shop database 59 according to the shop code 301/302/309. Then, the server device 50 sends the payment request including the product amount of money and the payment account 513 of the user to the payment unit, as well as sends an appropriation request including the product amount of money and the shop financial account 591 of the shop to the payment unit. Afterwards, the payment unit debits from the payment account 513 of the user according to the product amount of money of the payment request, as well as appropriates funds to the shop financial account 591 according to the product amount of money of the appropriation request. Thus, the identity identification system 102 of the present invention further identities the identity of the shop, so that the payment unit can prevent to appropriate funds to the unregistered shop, and therefore the security of the shopping payment can be further enhanced.

In the identity identification system 102 of the present embodiment, similarly, each of the wireless signal sensing devices 30 comprises the first encryption and decryption unit 37, the server device 50 comprises the second encryption and decryption unit 57. The wireless signal sensing device 30 is able to encrypt the first identification signal 115, the second identification signal 215, and the third identification signal 315 by the first encryption and decryption unit 37 to obtain a first encryption identification signal 117, a second encryption identification signal 217, and a third encryption identification signal 317. The first encryption identification signal 117, the second encryption identification signal 217, and the third encryption identification signal 317 are transmitted to the server device 50 by the wireless signal sensing device 30. The server device 50 is able to decrypt the first encryption identification signal 117, the second encryption identification signal 217, and the third encryption identification signal 317 by the second encryption and decryption unit 57 to obtain the first identification signal 115, the second identification signal 215, and the third identification signal 315. Accordingly, the identity identification system 102 of the present invention configures an encryption and decryption mechanism between the wireless signal sensing device 30 and the server device 50, the first identification signal 115, the second identification signal 215, and the third identification signal 315 transmitted by the wireless signal sensing device 30 may be protected by encryption so as to reduce the chance of the leakage of the user's shopping information and the shop code 301/302/309, and further ensure the security in the user's shopping payment.

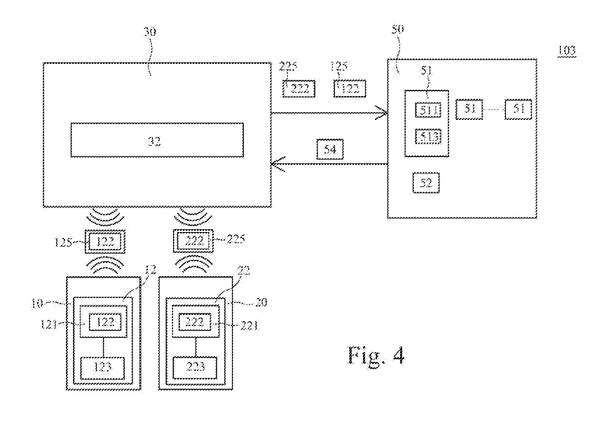

Referring to FIG. 4, there is shown a structural diagram of an identity identification system according to another application embodiment of the present invention. Comparing to the identity identification system 101/102 of the above-described embodiment sensing the signals 115, 215 transmitted from the RFID 11, 21 in the way of long-distance sensing, the identity identification system 103 of the present embodiment senses the signals 125, 225 transmitted by the RFID 12, 22 in a way of near field sensing.

In the present embodiment, the first RFID tag 12 is a RFID tag of high frequency capable of short-distance communication. The first RF chip 121 of the first RFID tag 12 is configured with the user identification code 122. The first RFID tag 12 can transmit a first identification signal 125 of short-distance by the first antenna 123. The first identification signal 125 includes the user identification code 122. The first RFID tag 12 is disposed on the portable object 10, for example, the membership card, the electronic ticket, the mobile phone, the hand ring, or other object for bearing the first RFID tag 12. In the present embodiment, the portable object 10 doesn't configure any credit card payment data. The second RFID tag 22 is also a RFID tag of high frequency capable of short-distance communication. The second RF chip 221 of the second RFID tag 22 is configured with the product information 222. The second RFID tag 22 can transmit a second identification signal 225 of short-distance by the second antenna 223. The second identification signal 225 includes the product information 222. The second RFID tag 22 is disposed on the product 20, for example, the goods, the drug, or other types of object.

The wireless signal sensing device 30 is an electronic device including a wireless signal sensor 32. The wireless signal sensor 32 is an RFID reader capable of sensing RF wireless signal of short-distance. The server device 50 comprises a plurality of user databases 51. Each of the user databases 51 is corresponding to a specific user, respectively. Each of the user databases 51 records the identity data 511 and the payment account 513 with regarding to each of user, respectively.

The identity identification system 103 of the present embodiment is applied in an identity identification of shopping payment. The wireless signal sensing device 30 is provided in a checkout area of a shop. The wireless signal sensing device 30 will sense the first identification signal 125 transmitted from the first RFID tag 12 and the second identification signal 225 transmitted from the second RFID tag 22 in a way of near field sensing when the portable object 10 and the product 20 held by the user are close to the wireless signal sensing device 30, and then transmit the first identification signal 125 and the second identification signal 225 to the server device 50. The server device 50 can generate the member identity identification result 52 according to the comparison between the user identification code 122 of the first identification signal 125 and the identity data 511 in each of the user databases 51, search out the payment account 513 of the corresponding user from the user databases 51 according to the member identity identification result 52. At the same time, the server device 50 know the product 20 taken away by the user and the product amount of money thereof according to the identification of the product information 222 of the second identification signal 225. Afterwards, the server device 50 sends a payment request including the product amount of money and the payment account 513 of the user to a payment unit. After the payment unit agrees the payment request of the server device 50, and debits from the payment account 513 of the user according to the product amount of money of the payment request, the service device 50 sends a payment completed notification message 54 to the wireless signal sensing device 30 and/or the mobile phone used by the user. Similarly, the identity identification system 103 of the present embodiment configures the encryption and decryption mechanism between the wireless signal sensing device 30 and the server device 50, the first identification signal 125 and the second identification signal 225 transmitted by the wireless signal sensing device 30 may be protected by encryption so as to reduce the chance of the leakage of the user's shopping information.

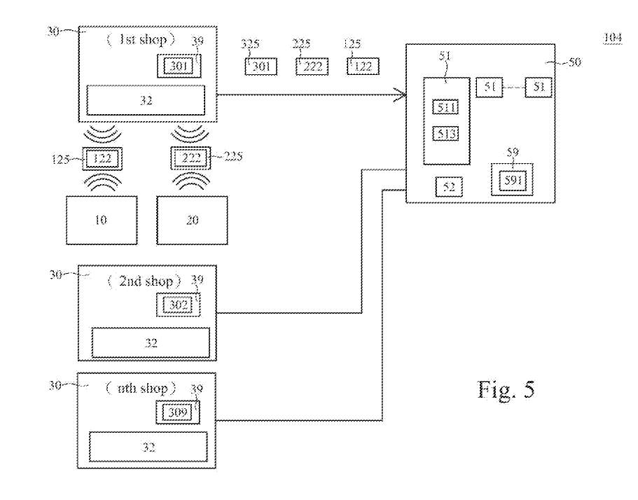

Referring to FIG. 5, there is shown a structural diagram of an identity identification system according to another application embodiment of the present invention. As shown in FIG. 5, the identity identification system 104 of the present embodiment further comprises a plurality of wireless signal sensing devices 30. Each of wireless signal sensing devices 30 is provided in a corresponding shop, respectively. The wireless signal sensing device 30 of each of shops is configured with a shop code, for example, the wireless signal sensing device 30 of the first shop is configured with the shop code 301, the wireless signal sensing device 30 of the second shop is configured with the shop code 302, and the wireless signal sensing device 30 of the nth shop is configured with the shop code 309. The shop code 301, 302, or 309 is stored in the data storage element 39 of each of wireless signal sensing devices 30.

When the identity identification system 104 is applied in the shopping payment, the wireless signal sensing devices 30 of the shop transmits simultaneously an third identification signal 325 including the shop code 301/302/309 to the server device 50 except for transmitting the first identification signal 125 and the second identification signal 225 to the server device 50. The server device 50 is able to generate the member identity identification result 52 according to the comparison between the user identification code 122 of the first identification signal 115 and the identity data 511 in each of the user databases 51, and search out the payment account 513 of the user from the user databases 51 according to the member identity identification result 52. The server device 50 is able to know the product amount of money, which is corresponding to the product 20 taken away by the user, according to the identification of the product information 222 of the second identification signal 225. The server device 50 is able to determine whether the shop that is transmitting the first identification signal 125, the second identification signal 225, and the third identification signal 325 is a registered shop according to the identification of the shop code 301/302/309 of the third identification signal 325. If the server device 50 has determined the shop as the registered shop according to the identification of the shop code 301/302/309, it will further search out the corresponding shop financial account 591 from the shop database 59 according to the shop code 301/302/309. Then, the server device 50 sends the payment request including the product amount of money and the payment account 513 of the user to the payment unit, as well as sends an appropriation request including the product amount of money and the shop financial account 591 of the shop to the payment unit. Afterwards, the payment unit debits from the payment account 513 of the user according to the product amount of money of the payment request, as well as appropriates funds to the shop financial account 591 according to the product amount of money of the appropriation request. Similarly, the identity identification system 104 of the present embodiment configures the encryption and decryption mechanism between the wireless signal sensing device 30 and the server device 50, the first identification signal 125, the second identification signal 225, and the third identification signal 325 transmitted by the wireless signal sensing device 30 may be protected by encryption so as to reduce the chance of the leakage of the user's shopping information and shop code 301/302/309.

As the above described, the wireless signal sensing device 30 in the checkout area of the shop will sense the user identification code 112/122 of the portable object 10 and the product information 222 of the product 20 in the way of long-distance sensing or near-field sensing when the portable object 10 and the product 20 held by the user enters the checkout area of the shop, and then the server device 50 will execute the shopping payment of the user according to the identification of the user identification code 112/122 and the product information 222. Besides, the credit card payment data 513 can avoid to be stolen during the payment process since the credit card payment data 513 are stored in the server device 50.

The above disclosure is only the preferred embodiment of the present invention, and not used for limiting the scope of the present invention. All equivalent variations and modifications on the basis of shapes, structures, features and spirits described in claims of the present invention should be included in the claims of the present invention.

What is claimed is:

1. An identity identification system, comprising:
a first RFID tag, being an RFID tag capable of long-distance communication, and disposed on a portable object, wherein the first RFID tag is for transmitting a first identification signal, the first identification signal is a wireless signal of long-distance, and includes a user identification code;
at least one wireless signal sensing device having a signal sensing area, wherein the wireless signal sensing device will sense the first identification signal in a way of long-distance sensing when the portable object carried by a user is through the signal sensing area of the wireless signal sensing device; and
a server device connected to the wireless signal sensing device, wherein the server device comprises a plurality of user databases, each of the user databases records an identity data with regarding to each of the users, respectively, the first identification signal is transmitted to the server device by the wireless signal sensing device, the server device is able to identify an identity of the user according to a comparison between the user identification code of the first identification signal and each of the identity data.

2. The identity identification system according to claim 1, wherein the user orders at least one goods on a member platform of the server device, the server device generates a pickup list according to the goods ordered by the user, and stores the pickup list to the corresponding user database.

3. The identity identification system according to claim 2, wherein the server device executes the comparison between the user identification code of the first identification signal and each of the identity data to generate a member identity identification result, the server device searches out the pickup list from the user databases according to the member identity identification result, the server device transmits the member identity identification result and the pickup list to the wireless signal sensing device, a service personnel at the signal sensing area of the wireless signal sensing device can determine the identity of the user based on the member identity identification result, and deliver the ordered goods to the ordered user based on the pickup list.

4. The identity identification system according to claim 1, wherein the identity identification system further comprises at least one second RFID tag, the second RFID tag is disposed on a product, the second RFID tag is for transmitting a second identification signal, the second identification signal is a wireless signal of long-distance and includes a product information, the wireless signal sensing device will sense the first identification signal and the second identification signal in the way of long-distance sensing when the portable object carried by the user and the product taken by the user are through the signal sensing area of the wireless signal sensing device, the first identification signal and the second identification signal are transmitted to the server device via the wireless signal sensing device, the server device is able to identify the identity of the user according to the comparison between the user identification code of the first identification signal and each of the identity data, and determine the product taken away by the user according to an identification of the product information of the second identification signal.

5. The identity identification system according to claim 4, wherein the first RFID tag comprises a first RF chip and a first antenna, the second RFID tag comprises a second RF chip and a second antenna, the first RF chip is configured with the user identification code, the first RF chip transmits the first identification signal including the user identification code by the first antenna, the second RF chip is configured with the product information, the second RF chip transmits the second identification signal including the product information by the second antenna.

6. The identity identification system according to claim 4, wherein the first RFID tag and the second RFID tag are an RFID tag of ultra high frequency, respectively.

7. The identity identification system according to claim 4, wherein each of the user databases further records a payment account of the user, respectively, the product information of the second identification signal comprises a product amount of money, the server device is able to search out the payment account of the user from the user databases according to the identification of the identity of the user, and know the product amount of money, which is corresponding to the product taken away by the user, according to the identification of the product information of the second identification signal, the server device sends a payment request including the product amount of money and the payment account of the user to a payment unit.

8. The identity identification system according to claim 7, wherein the payment account is a credit card data, a bank account number, an electronic wallet account or an electronic payment account.

9. The identity identification system according to claim 4, wherein the wireless signal sensing device comprises a first encryption and decryption unit, the server device comprises a second encryption and decryption unit, the wireless signal sensing device is able to encrypt the first identification signal and the second identification signal by the first encryption and decryption unit to obtain a first encryption identification signal and a second encryption identification signal, the first encryption identification signal and the second encryption identification signal are transmitted to the server device by the wireless signal sensing device, the server device is able to decrypt the first encryption identification signal and the second encryption identification signal by the second encryption and decryption unit to obtain the first identification signal and the second identification signal.

10. The identity identification system according to claim 4, wherein the identity identification system further comprises a photographic device that is connected to the wireless signal sensing device and provided in the signal sensing area, the photographic device is for shooting the user and the product taken away by the user to obtain an image data including a shooting time, the image data is transmitted to the server device by the wireless signal sensing device so as to store in the corresponding user database.

11. The identity identification system according to claim 1, wherein the identity identification system further comprises an alert unit that is connected to the wireless signal sensing device and provided in the signal sensing area, the server device sends an alert signal to the wireless signal sensing device when the server device identifies that the user identification code is an error identification code, the wireless signal sensing device drives the alert unit according to the alert signal.

12. The identity identification system according to claim 10, wherein the identity identification system further comprises an alert unit that is connected to the wireless signal sensing device and provided in the signal sensing area, the photographic device is a photographic device capable of tracking and detecting a moving object, the alert unit will be driven by the wireless signal sensing device when the photographic device detects that someone passes through the signal sensing area but the wireless signal sensing device does not sense the first identification signal.

13. The identity identification system according to claim 7, wherein the identity identification system comprises a plurality of the wireless signal sensing devices, each of the wireless signal sensing devices is provided in a corresponding shop and configured with a shop code, respectively, the server device further comprises a shop database that records a financial account of each of the shops, the wireless signal sensing device of the shop will sense the first identification signal and the second identification signal in the way of long-distance sensing when the portable object carried by the user and the product taken by the user are through the signal sensing area of the wireless signal sensing device of the shop, then, the first identification signal, the second identification signal, and a third identification signal including the shop code are transmitted to the server device via the wireless signal sensing device of the shop, the server device is able to identify the identity of the user according to the comparison between the user identification code of the first identification signal and each of the identity data, the server device is able to know the product amount of money, which is corresponding to the product taken away by the user, according to the identification of the product information of the second identification signal, the server device is able to determine whether the shop that is transmitting the first identification signal, the second identification signal, and the third identification signal is a registered shop according to an identification of the shop code of the third identification signal; afterwards, if the server device has determined the shop as the registered shop according to the identification of the shop code, it will further search out the corresponding shop financial account from the shop database according to the shop code, and send an appropriation request including the product amount of money and the shop financial account to the payment unit.

14. The identity identification system according to claim 13, wherein the wireless signal sensing device comprises a first encryption and decryption unit, the server device comprises a second encryption and decryption unit, the wireless signal sensing device is able to encrypt the first identification signal, the second identification signal, and the third identification signal by the first encryption and decryption unit to obtain a first encryption identification signal, a second encryption identification signal, and a third encryption identification signal, the first encryption identification signal, the second encryption identification signal, and the third encryption identification signal are transmitted to the server device by the wireless signal sensing device, the server device is able to decrypt the first encryption identification signal, the second encryption identification signal, and the third encryption identification signal by the second encryption and decryption unit to obtain the first identification signal, the second identification signal, and the third identification signal.

15. An identity identification method, which is applied in an identity identification system, wherein the identity identification system comprises a first RFID tag, at least one wireless signal sensing device, and a server device, the first RFID tag is an RFID tag capable of long-distance communication and disposed on a portable object, the wireless signal sensing device is having a signal sensing area, the server device comprises a plurality of user databases, each of the user databases records an identity data with regarding to each of the users, respectively, steps of the identity identification method comprising:
transmitting a first identification signal including a user identification code by the first RFID tag;
enabling the wireless signal sensing device sensing the first identification signal transmitted by the first RFID tag in a way of long-distance sensing when the portable object carried by a user is through the signal sensing area of the wireless signal sensing device;
transmitting the first identification signal to the server device by the wireless signal sensing device; and
enabling the server device executing a comparison between the user identification code of the first identification signal and each of the identity data to identify an identity of the user.

16. The identity identification method according to claim 15, the steps of the identity identification method further comprising:
ordering at least one goods on a member platform of the server device by the user so that the server device generates a pickup list and stores the pickup list to the corresponding user database;
enabling the server device executing the comparison between the user identification code of the first identification signal and each of the identity data to generate a member identity identification result;
searching out the pickup list from the user databases according to the member identity identification result by the server device;
transmitting the member identity identification result and the pickup list to the wireless signal sensing device by the server device; and
demanding a service personnel at the signal sensing area of the wireless signal sensing device to determine the identity of the user based on the member identity identification result and deliver the ordered goods to the ordered user based on the pickup list.

17. The identity identification method according to claim 15, wherein the identity identification system further comprises a second RFID tag disposed on a product, the steps of the identity identification method further comprising:
transmitting a second identification signal comprising a product information by the second RFID tag;
enabling the wireless signal sensing device sensing the first identification signal transmitted by the first RFID tag and the second identification signal transmitted by the second RFID tag in the way of long-distance sensing when the portable object carried by the user and the product taken by the user is through the signal sensing area of the wireless signal sensing device;
transmitting the first identification signal and the second identification signal to the server device by the wireless signal sensing device;
enabling the server device executing the comparison between the user identification code of the first identification signal and each of the identity data to identify the identity of the user; and
determining the product taken away by the user according to an identification of the product information of the second identification signal.

18. The identity identification method according to claim 17, wherein each of the user databases further records a payment account of the user, respectively, the product information of the second identification signal comprises a product amount of money, the steps of the identity identification method further comprising:
searching out the payment account of the user from the user databases according to the identification of the identity of the user by the server device;
enabling the server device identifying the product information of the second identification signal to know the product amount of money that is corresponding to the product taken away by the user; and
sending a payment request including the product amount of money and the payment account of the user to a payment unit by the server device.

19. The identity identification method according to claim 17, the steps of the identity identification method further comprising:
enabling the wireless signal sensing device encrypting the first identification signal and the second identification signal by a first encryption and decryption unit to obtain a first encryption identification signal and a second encryption identification signal;
transmitting the first encryption identification signal and the second encryption identification signal to the server device by the wireless signal sensing device; and
enabling the server device decrypting the first encryption identification signal and the second encryption identification signal by a second encryption and decryption unit to obtain the first identification signal and the second identification signal.

20. The identity identification method according to claim 17, wherein the identity identification system comprises a plurality of the wireless signal sensing devices, each of the wireless signal sensing devices is provided in a corresponding shop and configured with a shop code, respectively, the server device further comprises a shop database that records a financial account of each of the shops, the steps of the identity identification method further comprising:
transmitting the first identification signal, the second identification signal, and a third identification signal including the shop code to the server device by the wireless signal sensing device of the shop;
enabling the server device identifying the product information of the second identification signal to know the product amount of money that is corresponding to the product taken away by the user;
enabling the server device identifying the shop code of the third identification signal to determine whether the shop that is transmitting the first identification signal, the second identification signal, and the third identification signal is a registered shop;
enabling the server device searching out the corresponding shop financial account from the shop database according to the shop code when the shop has determined as the registered shop; and
sending an appropriation request including the product amount of money and the shop financial account to the payment unit by the server device.

21. The identity identification method according to claim 20, the steps of the identity identification method further comprising:
enabling the wireless signal sensing device encrypting the first identification signal, the second identification signal, and the third identification signal by a first encryption and decryption unit to obtain a first encryption identification signal, a second encryption identification signal, and a third encryption identification signal;
transmitting the first encryption identification signal, the second encryption identification signal, and the third encryption identification signal to the server device by the wireless signal sensing device; and
enabling the server device decrypting the first encryption identification signal, the second encryption identification signal, and the third encryption identification signal by a second encryption and decryption unit to obtain the first identification signal, the second identification signal, and the third identification signal.

22. An identity identification system, comprising:
a first RFID tag, being a RFID tag capable of short-distance communication, and disposed on a portable object, wherein the first RFID tag is for transmitting a first identification signal, the first identification signal is a wireless signal of short-distance, and includes a user identification code;
at least one second RFID tag, being a RFID tag capable of short-distance communication, and disposed on a product, respectively, wherein the second RFID tag is for transmitting a second identification signal, the second identification signal is a wireless signal of short-distance and includes a product information comprising a product amount of money;
at least one wireless signal sensing device, wherein the wireless signal sensing device will sense the first identification signal and the second identification signal in a way of near field sensing when the portable object and the product held by a user are close to the wireless signal sensing device; and
a server device connected to the wireless signal sensing device, wherein the server device comprises a plurality of user databases, each of the user databases records an identity data and a payment account with regarding to each of the users, respectively, the first identification signal and the second identification signal are transmitted to the server device by the wireless signal sensing device, the server device is able to identify an identity of the user according to a comparison between the user identification code of the first identification signal and each of the identity data, and further search out the payment account of the user from the user databases according to the identity of the user, the server device is able to know the product amount of money, which is corresponding to the product taken away by the user, according to the identification of the product information of the second identification signal, afterwards, the server device sends a payment request including the product amount of money and the payment account of the user to a payment unit.

23. The identity identification system according to claim 22, wherein the identity identification system comprises a plurality of the wireless signal sensing devices, each of the wireless signal sensing devices is provided in a corresponding shop and configured with a shop code, respectively, the server device further comprises a shop database that records a financial account of each of the shops, the wireless signal sensing device of the shop will sense the first identification signal and the second identification signal in the way of near field sensing when the portable object and the product held by a user are close to the wireless signal sensing device of the shop, then, the first identification signal, the second identification signal, and a third identification signal including the shop code are transmitted to the server device via the wireless signal sensing device of the shop, the server device is able to identify the identity of the user according to the comparison between the user identification code of the first identification signal and each of the identity data, the server device is able to know the product amount of money, which is corresponding to the product taken away by the user, according to the identification of the product information of the second identification signal, the server device is able to determine whether the shop that is transmitting the first identification signal, the second identification signal, and the third identification signal is a registered shop according to an identification of the shop code of the third identification signal; afterwards, if the server device has determined the shop as the registered shop according to the identification of the shop code, it will further search out the corresponding shop financial account from the shop database according to the shop code, and send an appropriation request including the product amount of money and the shop financial account to the payment unit.

24. An identity identification method, which is applied in an identity identification system, wherein the identity identification system comprises a first RFID tag, at least one second RFID tag, at least one wireless signal sensing device, and a server device, the first RFID tag is a RFID tag capable of short-distance communication and disposed on a portable object, the second RFID tag is a RFID tag capable of short-distance communication and disposed on a product, the server device comprises a plurality of user databases, each of the user databases records an identity data and a payment account with regarding to each of the users, respectively, steps of the identity identification method comprising:
transmitting a first identification signal including a user identification code by the first RFID tag;
transmitting a second identification signal including a product information by the second RFID tag;
enabling the wireless signal sensing device sensing the first identification signal transmitted by the first RFID tag and the second identification signal transmitted by the second RFID tag in a way of near field sensing when the portable object and the product held by a user are close to the wireless signal sensing device;
transmitting the first identification signal and the second identification signal to the server device by the wireless signal sensing device;
enabling the server device executing the comparison between the user identification code of the first identification signal and each of the identity data to identify the identity of the user;
searching out the payment account of the user from the user databases according to the identity of the user by the server device;
enabling the server device identifying the product information of the second identification signal to know the product amount of money that is corresponding to the product taken away by the user; and
sending a payment request including the product amount of money and the payment account of the user to a payment unit by the server device.

25. The identity identification method according to claim 24, wherein the identity identification system comprises a plurality of the wireless signal sensing devices, each of the wireless signal sensing devices is provided in a corresponding shop and configured with a shop code, respectively, the server device further comprises a shop database that records a financial account of each of the shops, the steps of the identity identification method further comprising:
transmitting the first identification signal, the second identification signal, and a third identification signal including the shop code to the server device by the wireless signal sensing device of the shop;
enabling the server device identifying the shop code of the third identification signal to determine whether the shop that is transmitting the first identification signal, the second identification signal, and the third identification signal is a registered shop;
enabling the server device searching out the corresponding shop financial account from the shop database according to the shop code when the shop has determined as the registered shop; and
sending an appropriation request including the product amount of money and the shop financial account to the payment unit by the server device.
